(19) United States
(12) Patent Application Publication
(10) Pub. No.: US 2019/0179953 A1
(43) Pub. Date: Jun. 13, 2019

(54) RECOMMENDING APPLICATION PROGRAMS BASED ON A USER'S PREVIOUS EXPERIENCE RATING

(71) Applicant: International Business Machines Corporation, Armonk, NY (US)

(72) Inventors: Eric V. Kline, Rochester, MN (US); Sarbajit K. Rakshit, Kolkata (IN)

(21) Appl. No.: 15/838,807

(22) Filed: Dec. 12, 2017

(51) Int. Cl. G06F 17/30; H04L 29/08

(52) U.S. Cl. CPC G06F 17/30699; H04L 67/22; G06F 17/30867

(57) ABSTRACT

A method includes determining a plurality of user-experience ratings relating to a user's previous use of a plurality of functions of a plurality of application programs. At least one user-experience rating of the plurality of user-experience ratings includes a previous best user-experience rating for a function of the plurality of functions. The previous best user-experience rating corresponds to the best previous experience that the user had when using the function. The method also includes determining at least one application program to recommend. The recommended at least one application program is configured to perform the function. The determining the at least one application program to recommend includes determining that the at least one application program will offer a similar or better user experience compared to the user experience corresponding to the previous best user-experience rating. The method also includes recommending the determined at least one application program to the user.

### BACKGROUND

One or more embodiments relate in general to recommending application programs based on a user's previous experience rating. More specifically, one or more embodiments can relate to recommending application programs based on a user's previous best experience rating.

An application program (also referred to as an “app”) is a computer program product that causes a processor to perform one or more functional tasks for a user of the application program. Application programs can be implemented on computers, smartphones, digital assistants, tablets, laptops, and/or any other type of personal electronic device. Application programs can perform functional tasks relating to photo editing, games/entertainment, social media, displaying of news, word processing, web browsing, displaying of media, playing music, etc.

### SUMMARY

According to one or more embodiments, a method includes determining a plurality of user-experience ratings relating to a user's previous use of a plurality of functions of a plurality of application programs. At least one user-experience rating of the plurality of user-experience ratings includes a previous best user-experience rating for a function of the plurality of functions, and the previous best user-experience rating corresponds to the best previous experience that the user had when using the function. The method also includes determining at least one application program to recommend to the user. The recommended at least one application program is configured to perform the function. The determining the at least one application program to recommend includes determining that the at least one application program will offer a similar or better user experience compared to the user experience corresponding to the previous best user-experience rating. The method also includes recommending the determined at least one application program to the user.

According to one or more embodiments, a computer system includes a memory. The computer system includes a processor system communicatively coupled to the memory. The processor system is configured to perform a method that includes determining a plurality of user-experience ratings relating to a user's previous use of a plurality of functions of a plurality of application programs. At least one user-experience rating of the plurality of user-experience ratings includes a previous best user-experience rating for a function of the plurality of functions, and the previous best user-experience rating corresponds to the best previous experience that the user had when using the function. The method also includes determining at least one application program to recommend to the user. The recommended at least one application program is configured to perform the function, and the determining the at least one application program to recommend includes determining that the at least one application program will offer a similar or better user experience compared to the user experience corresponding to the previous best user-experience rating. The method also includes recommending the determined at least one application program to the user.

According to one or more embodiments, a computer program product includes a computer-readable storage medium having program instructions embodied therewith. The computer-readable storage medium is not a transitory signal per se, the program instructions readable by a processor system to cause the processor system to perform a method including determining a plurality of user-experience ratings relating to a user's previous use of a plurality of functions of a plurality of application programs. At least one user-experience rating of the plurality of user-experience ratings includes a previous best user-experience rating for a function of the plurality of functions, and the previous best user-experience rating corresponds to the best previous experience that the user had when using the function. The processor system is also configured to determine at least one application program to recommend to the user. The recommended at least one application program is configured to perform the function. The determining the at least one application program to recommend includes determining that the at least one application program will offer a similar or better user experience compared to the user experience corresponding to the previous best user-experience rating. The processor system is also configured the determined at least one application program to recommend to the user.

### BRIEF DESCRIPTION OF THE DRAWINGS

The subject matter of one or more embodiments is particularly pointed out and distinctly defined in the claims at the conclusion of the specification. The foregoing and other features and advantages are apparent from the following detailed description taken in conjunction with the accompanying drawings in which:

FIG. 1 illustrates user experience ratings for a plurality of functions, for each of a plurality of application programs in accordance with one or more embodiments;

FIG. 2 illustrates determining a set of average user experience ratings and a set of previous best user experience ratings in accordance with one or more embodiments;

FIG. 3 illustrates determining a personalized set of user experience ratings for functions of an example application, based on a set of user experience ratings provided by global users and a set of average user experience ratings provided by a user, in accordance with one or more embodiments;

FIG. 4 illustrates comparing a personalized set of ratings against a set of previous best user-experience ratings in accordance with one or more embodiments;

FIG. 5 depicts a flowchart of a method, in accordance with one or more embodiments;

FIG. 6 depicts a high-level block diagram of a computer system, which can be used to implement one or more embodiments; and

FIG. 7 depicts a computer program product, in accordance with one or more embodiments.

### DETAILED DESCRIPTION

In accordance with one or more embodiments, methods and computer program products for recommending application programs based on a user's previous experience rating are provided. Various embodiments are described herein with reference to the related drawings. Alternative embodiments can be devised without departing from the scope of this invention. References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Additionally, although this disclosure includes a detailed description of a computing device configuration, implementation of the teachings recited herein are not limited to a particular type or configuration of computing device(s). Rather, embodiments of the present disclosure are capable of being implemented in conjunction with any other type or configuration of wireless or non-wireless computing devices and/or computing environments, now known or later developed.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

For the sake of brevity, conventional techniques related to computer processing systems and computing models may or may not be described in detail herein. Moreover, it is understood that the various tasks and process steps described herein can be incorporated into a more comprehensive procedure, process or system having additional steps or functionality not described in detail herein.

Different types of application programs can be configured to cause a user device to perform different functions on behalf of a user. The user can have different user experiences when using each of the different functions of each application program. Each of the different functions can be associated with a separate user experience.

When the user installs and uses a new application program, the user is likely to compare the new application program against application programs that the user has previously used. Specifically, the user can compare the user experiences associated with each function of the new application program against the user experiences associated with each corresponding function of one or more previously-used application programs. For example, the user can compare the usability of each function of the new application program against the usability of each similar function that is provided by a previously-used application program.

Upon comparing the new application program to the previously-used application programs, if the user determines that the user experiences associated with the new application program are unsatisfactory compared to the user experiences of the previous programs, then the user will likely delete the new application program and instead try a different new application program. This process of trying new application programs and deleting unsatisfactory new application programs can be time-consuming and frustrating to the user.

For example, suppose that a user is already experienced in using Application Program A (referred to as “App A”). Suppose also that App A performs the function of allowing a user to share a file with a single user gesture (such as allowing a user to share the file with a single touch). Next, suppose that the user also installs a new application program, Application Program B (referred to as “App B”), and the user determines that sharing files with App B is more difficult/tedious compared to sharing files with App A. Because the user has previously shared files using App A and considers App A to provide the best user experience, the user will inevitably compare the user experience of using the file-sharing functionality of App B against the user experience of using the file-sharing functionality of App A.

In other words, when a user searches through a collection of application programs for a new application to use/install, the user will inevitably compare the functions of the new application program with the functions of the previously-used application programs. As such, the user will search through the collection of application programs for a new application program that will likely provide user experiences that are similar to or better than the best user experiences that are provided by the previous application programs.

In view of the above, one or more embodiments are directed to a method and system that searches for and recommends application programs which are likely to provide levels of user experience that are the same or better than the user's previous best user experiences. With one or more embodiments, a computer program product can monitor/track actions that are performed by the user on the user device. Specifically, the computer program product can track when the user accesses an application program, and the computer program product can track the instances where the user performs each function of the application program. The computer program product can also capture feedback that is provided by the user as the user performs each function of the application program. For example, with one or more embodiments, the computer program product can capture the user's facial expressions while the user performs each function for the first time, the second time, third time, etc. One or more embodiments can also capture voice or textual feedback that the user provides relating to the use of different functions of the application program. The feedback can take the form of different ratings corresponding to the user experiences that are associated with the functions of the computer program product.

After capturing the feedback/ratings that are provided by the user, the computer program product can store the captured feedback/rating information (regarding the different functions of the used application program) to an application server. The application server can be a cloud server, for example. The application server can be specifically configured to provide recommendations for application programs. In one or more embodiments, the application server can operate in conjunction with a collection of application programs. In order to perform the one or more different functions, the application program can provide different menus, display options, and/or navigation criteria, for example. The user can also provide feedback/ratings regarding the ability to use offline data that is provided by the application program, and the user can also provide feedback/ratings regarding the promptness of providing the desired functionality, for example.

The functions that are provided by the application programs can be high-level features such as, for example, the navigation function of application programs. Each of the high-level features can be implemented with lower-level features such as, for example, reception of mouse input, reception of voice input, and/or reception of body-gesture input, for example. Another example of lower-level features for supporting the higher-level navigation features can include use of a standard display, use of a virtual reality display, etc. With one or more embodiments, the user can provide feedback regarding the user experience of using high-level features as well as low-level features.

One or more embodiments can also assign a higher level of importance to a user experience associated with one function over another user experience that is associated with another function. For example, one or more embodiments can assign weightings that reflect the importance of different functions/features to the user. For example, depending on the preferences of the user, one or more embodiments can assign a greater or lesser weight to display features as compared to navigation features.

With one or more embodiments, the application server that stores the feedback/rating information can perform contextual analysis upon the feedback/rating information. For example, in one or more embodiments, the application server can perform contextual analysis upon a user's stored facial expression of when the user uses a function. The application server can also aggregate the feedback reflecting the user's experience for each function that is used. The aggregated feedback for each function can then be assigned a rating/score. As such, each function of an application can be assigned a rating/score that reflects the feedback of the user. With one or more embodiments, the application server can rank and store the received feedback regarding the user experience for each function of each application program.

When the user searches through a collection of application programs (such as, for example, an application program store) for a new application program to install/use, the application server can provide options of different application programs for the user to install, and the application server can display the different functionalities that are performable by each of the provided application programs.

One or more embodiments can determine the user's previous best user-experiences (or ratings of user experiences) that are associated to the different identified functions of the provided application programs. With one or more embodiments, the cloud server can then recommend the provided application programs based on the user's previous best user experiences relating to the different identified functions of the provided application programs. In one or more embodiments, the cloud server can use a created knowledgebase to rank the functions of the provided application programs in accordance to the preferences of the user.

When the user searches through the different options of application programs that are displayed to the user, one or more embodiments can recommend application programs that will likely provide the user with user experience(s) that are predicted to be the same or better than the user's previous user experiences. Accordingly, upon referring to the recommended application programs by one or more embodiments, the user can select an appropriate application program.

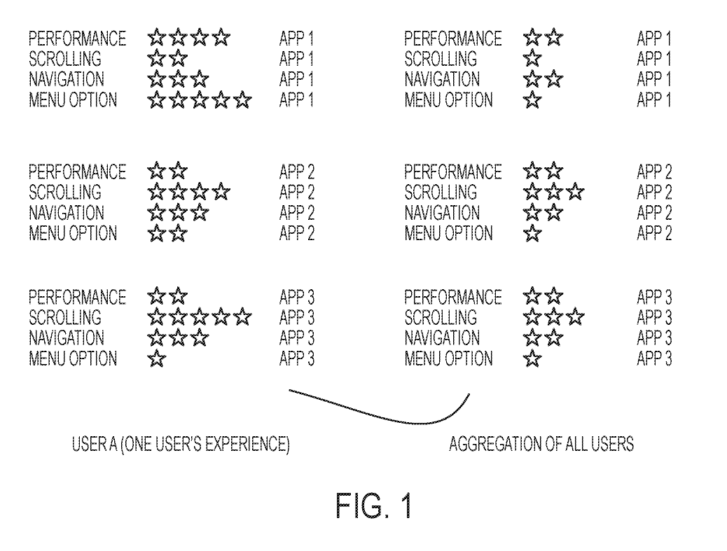

FIG. 1 illustrates user experience ratings for a plurality of functions, for each of a plurality of application programs in accordance with one or more embodiments. FIG. 1 illustrates user experience ratings that are provided by User A for each of the example functions (i.e., Performance, Scrolling, Navigation, Menu Option) for each of the example applications (i.e., App1, App2, and App3). Other embodiments can have different sets of functions and different sets of applications. Referring to FIG. 1, User A has rated the “Performance” of “App1” as 4 stars. User A has rated the “Scrolling” of “App1” as 2 stars. User A has rated the “Navigation” of “App1” as 3 stars. The ratings shown for User A, in FIG. 1, can be based on a captured facial feedback, voice feedback, and/or textual feedback, for example.

FIG. 1 also illustrates user experience ratings that are provided by global users for each of the example functions (i.e., Performance, Scrolling, Navigation, Menu Option) for each of the example applications (i.e., App1, App2, and App3). Global users can be users around the world which have provided ratings for the functions of the application programs. The global users have rated the “Performance” of “App1” as 2 stars. The global users have rated the “Scrolling” of “App1” as 1 star. The global users have rated the “Navigation” of “App1” as 2 stars. Therefore, for each application program that User A provides ratings for, there may be a corresponding set of ratings that have been provided by global users.

In order to determine the above-described user experience ratings, with one or more embodiments, a camera or other sensor can be installed on the user's device, and the camera/sensor can track the user's actions and interactions with a functionality of an application program. The user's facial feedback, voice feedback, and/or textual feedback can then be collected to determine the user experience ratings.

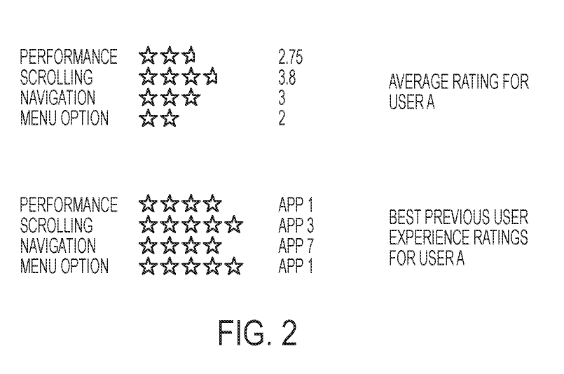

FIG. 2 illustrates determining a set of average user experience ratings and a set of previous best user experience ratings in accordance with one or more embodiments. With regard to the set of average user experience ratings, User A has rated a plurality of different functions of different application programs, and the average rating that is provided for “Performance” by User A (across all application programs rated by User A) is 2.75 stars. The average rating that is provided for “Scrolling” by User A is 3.8.

With regard to the set of previous best user experience ratings, the best rating that User A has provided for the “Performance” function is four stars, when User A was using App1. The best rating that User A has provided for the “Scrolling” function is five stars when User A was using App3.

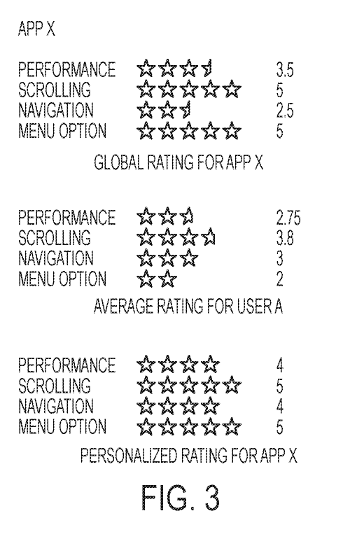

FIG. 3 illustrates determining a personalized set of user experience ratings for functions of an example application, based on a set of user experience ratings provided by global users and a set of average user experience ratings provided by a user, in accordance with one or more embodiments. Suppose that User A has not yet used App X (and thus User A has not yet provided ratings for App X). However, suppose that global users have provided user experience ratings for the functions of App X, where “Performance” is globally rated at 3.5 stars, “Scrolling” is globally rated at 5 stars, etc. Further, suppose that User A has a set of average user experience ratings, which can be based on the average of ratings of the functions that User A has provided, for all application programs for which User A has provided ratings for. For example, the average rating that User A has provided for “Performance” (across all application programs that User A has provided ratings for) is 2.75 stars. Further, although User A has not yet provided ratings for App X, one or more embodiments can determine a set of ratings that are personalized for User A for App X. In other words, although User A has Trot yet provided ratings for App X, one or more embodiments can infer a set of ratings for User A for App X. One or more embodiments can calculate a set of personalized ratings for User A for App X based at least on the global ratings for App X and the average ratings that are provided by User A. In other words, one or more embodiments can perform analysis on the ratings that are provided by User A and on the ratings that are provided by global users in order to determine correlations between User A and the global ratings. In one or more embodiments of the invention, the correlations can be based on global ratings that are provided by global users for the same application programs for which User A has provided ratings for. Other embodiments can use other global ratings. These determined correlations can then be used by one or more embodiments to determine the set of ratings for App X that are personalized for User A.

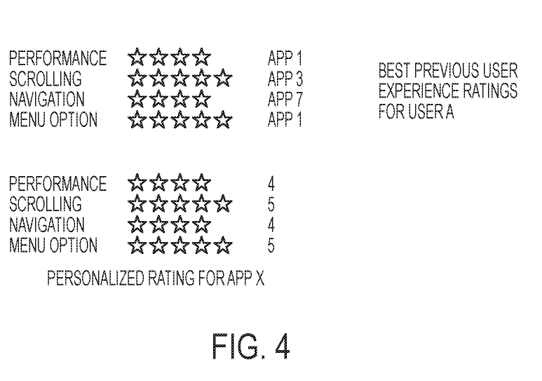

FIG. 4 illustrates comparing a personalized set of ratings against a set of previous best user-experience ratings in accordance with one or more embodiments. As previously described with respect to FIG. 3, one or more embodiments can determine/infer a set of personalized ratings for User A for App X. The personalized set of ratings for User A for App X (as shown in FIG. 3 and FIG. 4) has rated “Performance” at 4 stars, “Scrolling” at 5 stars, “Navigation” at 4 stars, and “Menu Option” at 5 stars. As previously described in FIG. 2, one or more embodiments can also determine a set of previous best user-experience ratings. For example, the best rating that User A has provided for the “Performance” function is four stars, when User A was using App1. The best rating that User A has provided for the “Scrolling” function is five stars, when User A was using App3. One or more embodiments can then compare the personalized set of ratings against the set of previous best user-experience ratings in order to determine whether or not App X should be recommended to User A. In one or more embodiments, an application program can be recommended to the user if the application program can provide at least one user experience rating (corresponding to at least one function) that meets or exceeds at least one previous best user-experience rating. In the example of FIG. 4, one or more embodiments can recommend App X to User A because App X provides a set of user experiences that meets all the previous best user-experience ratings of User A. For example, the personalized rating for “Performance” for App X meets the previous best user-experience rating for User A because both the personalized rating and the best user-experience rating is 4 stars. Similarly, in the example of FIG. 4, the other personalized ratings for App X also meet the previous best user-experience ratings.

As a user searches through a collection of application programs to install/use, one or more embodiments can recommend application programs that perform a function that the user is searching for and that also meet at least one previous best user-experience rating. Once a user searches for a new application program to use/install, a computer program product of one or more embodiments can search through the collection of application programs and can accordingly identify what functions are provided by the options of application programs. For example, if the user is searching for application programs that perform the function of booking travel, all application programs that perform the function of booking travel can be automatically evaluated by one or more embodiments to determine whether any of the application programs can also meet at least one previous best user-experience rating.

One or more embodiments can also compare global user experience ratings of application programs against a user's previous best user experience ratings in order to determine whether the application programs meet or exceed the user's previous best user experience ratings. Therefore, one or more embodiments recommend the application programs which are likely to provide a similar or better user experience compared to the user experience that has been previously provided. In view of the above, options of application programs that are presented to users for use/installation can be filtered and thus the user can more readily select the appropriate application program.

With one or more embodiments of the invention, the one or more recommended application programs can appear more prominently in search results when the user searches for an application program to install. Upon seeing the recommended application programs, the user can then decide whether or not to install any new application program. With one more embodiments of the invention, a message that suggests installing the one or more recommended application programs can be transmitted to the user. With other embodiments of the invention, the one or more recommended application programs can be automatically installed on the user's device if the one or more recommended application programs have not yet been installed on the user's device. With one or more embodiments of the invention, the automatic installation can be performed only if the cost of installation is below a threshold cost.

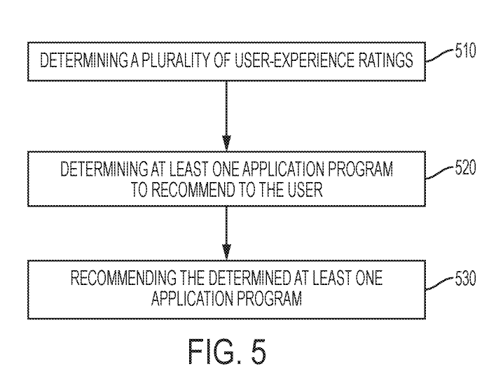

FIG. 5 depicts a flowchart of a method in accordance with one or more embodiments. The method of FIG. 5 can be performed by a controller of a system that is configured to provide recommendations for application programs. The method of FIG. 5 can be performed by an application server. For example, the method of FIG. 5 can be performed by a processor of an application server of a recommendation system. The application server can be a special-purpose application server that performs the specific functionality illustrated by FIG. 5. The method includes, at block 510, determining a plurality of user-experience ratings relating to a user's previous use of a plurality of functions of a plurality of application programs. At least one user-experience rating of the plurality of user-experience ratings includes a previous best user-experience rating for a function of the plurality of functions, and the previous best user-experience rating corresponds to the best previous experience that the user had when using the function. The method includes, at block 520, determining at least one application program to recommend to the user. The recommended at least one application program is configured to perform the function, and the determining the at least one application program to recommend includes determining that the at least one application program will offer a similar or better user experience compared to the user experience corresponding to the previous best user-experience rating. With one or more embodiments of the invention, the at least one recommended application program can be a recommended application program that has been filtered by application type. In other words, in addition to meeting at least one best user-experience rating, the recommended application program also performs a function that the user is searching for (e.g., booking travel, etc.). The method also includes, at block 530, recommending the determined at least one application program to the user. With one or more embodiments of the invention, if there is a plurality of recommended applications, then the recommended applications can be presented in a prioritized manner, where the recommended applications with higher ratings are presented first, for example. With one or more embodiments of the invention, the ratings of the recommended applications can be personalized ratings for the user. Alternatively, the ratings of the recommended applications can be based on global ratings.

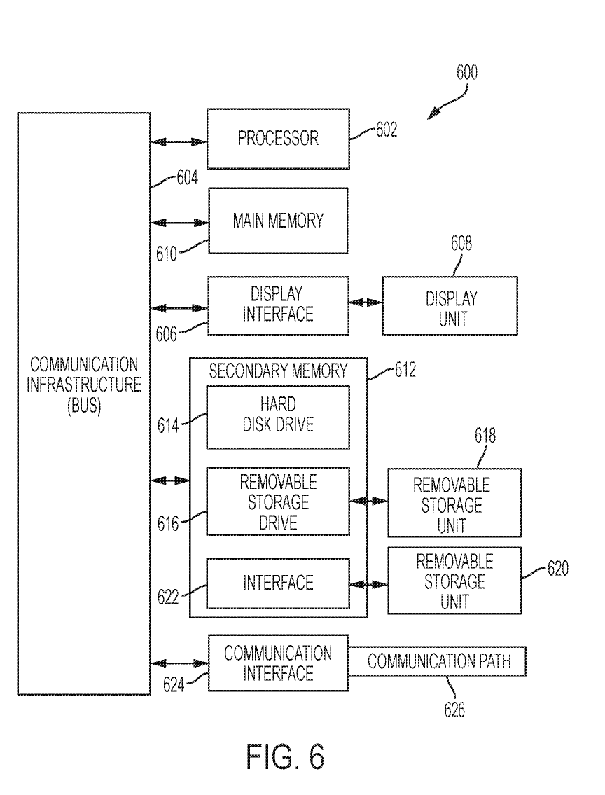

FIG. 6 depicts a high-level block diagram of a computer system 600, which can be used to implement one or more embodiments. Computer system 600 can correspond to, at least, an application server that stores/analyzes ratings and that recommends application programs, for example. Computer system 600 can be used to implement hardware components of systems capable of performing methods described herein. Although one exemplary computer system 600 is shown, computer system 600 includes a communication path 626, which connects computer system 600 to additional systems (not depicted) and can include one or more wide area networks (WANs) and/or local area networks (LANs) such as the Internet, intranet(s), and/or wireless communication network(s). Computer system 600 and additional system are in communication via communication path 626, e.g., to communicate data between them.

Computer system 600 includes one or more processors, such as processor 602. Processor 602 is connected to a communication infrastructure 604 (e.g., a communications bus, cross-over bar, or network). Computer system 600 can include a display interface 606 that forwards graphics, textual content, and other data from communication infrastructure 604 (or from a frame buffer not shown) for display on a display unit 608. Computer system 600 also includes a main memory 610, preferably random access memory (RAM), and can also include a secondary memory 612. Secondary memory 612 can include, for example, a hard disk drive 614 and/or a removable storage drive 616, representing, for example, a floppy disk drive, a magnetic tape drive, or an optical disc drive. Hard disk drive 614 can be in the form of a solid state drive (SSD), a traditional magnetic disk drive, or a hybrid of the two. There also can be more than one hard disk drive 614 contained within secondary memory 612. Removable storage drive 616 reads from and/or writes to a removable storage unit 618 in a manner well known to those having ordinary skill in the art. Removable storage unit 618 represents, for example, a floppy disk, a compact disc, a magnetic tape, or an optical disc, etc. which is read by and written to by removable storage drive 616. As will be appreciated, removable storage unit 618 includes a computer-readable medium having stored therein computer software and/or data.

In alternative embodiments, secondary memory 612 can include other similar means for allowing computer programs or other instructions to be loaded into the computer system. Such means can include, for example, a removable storage unit 620 and an interface 622. Examples of such means can include a program package and package interface (such as that found in video game devices), a removable memory chip (such as an EPROM, secure digital card (SD card), compact flash card (CF card), universal serial bus (USB) memory, or PROM) and associated socket, and other removable storage units 620 and interfaces 622 which allow software and data to be transferred from the removable storage unit 620 to computer system 600.

Computer system 600 can also include a communications interface 624. Communications interface 624 allows software and data to be transferred between the computer system and external devices. Examples of communications interface 624 can include a modem, a network interface (such as an Ethernet card), a communications port, or a PC card slot and card, a universal serial bus port (USB), and the like. Software and data transferred via communications interface 624 are in the form of signals that can be, for example, electronic, electromagnetic, optical, or other signals capable of being received by communications interface 624. These signals are provided to communications interface 624 via a communication path (i.e., channel) 626. Communication path 626 carries signals and can be implemented using wire or cable, fiber optics, a phone line, a cellular phone link, an RF link, and/or other communications channels.

In the present description, the terms “computer program medium,” “computer usable medium,” and “computer-readable medium” are used to refer to media such as main memory 610 and secondary memory 612, removable storage drive 616, and a hard disk installed in hard disk drive 614. Computer programs (also called computer control logic) are stored in main memory 610 and/or secondary memory 612. Computer programs also can be received via communications interface 624. Such computer programs, when run, enable the computer system to perform the features discussed herein. In particular, the computer programs, when run, enable processor 602 to perform the features of the computer system. Accordingly, such computer programs represent controllers of the computer system. Thus it can be seen from the foregoing detailed description that one or more embodiments provide technical benefits and advantages.

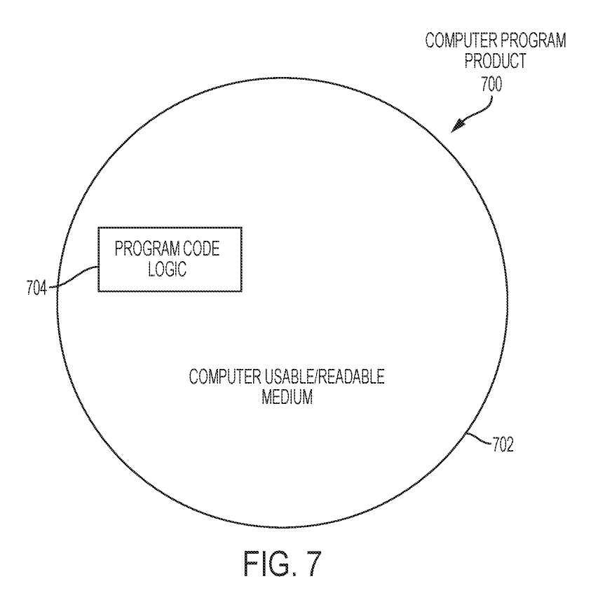

FIG. 7 depicts a computer program product 700, in accordance with an embodiment. Computer program product 700 includes a computer-readable storage medium 702 and program instructions 704.

Embodiments can be a system, a method, and/or a computer program product. The computer program product can include a computer-readable storage medium (or media) having computer-readable program instructions thereon for causing a processor to carry out aspects of one or more embodiments.

The computer-readable storage medium can be a tangible device that can retain and store instructions for use by an instruction execution device. The computer-readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out embodiments can include assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer-readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform one or more embodiments.

Aspects of various embodiments are described herein with reference to flowchart illustrations and/or block diagrams of methods, apparatus (systems), and computer program products according to various embodiments. It will be understood that each block of the flowchart illustrations and/or block diagrams, and combinations of blocks in the flowchart illustrations and/or block diagrams, can be implemented by computer-readable program instructions.

These computer-readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions can also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments described. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments described herein.

What is claimed is:

1. A computer-implemented method, the method comprising:
determining a plurality of user-experience ratings relating to a user's previous use of a plurality of functions of a plurality of application programs, wherein at least one user-experience rating of the plurality of user-experience ratings comprises a previous best user-experience rating for a function of the plurality of functions, and the previous best user-experience rating corresponds to the best previous experience that the user had when using the function;
determining at least one application program to recommend to the user, wherein the recommended at least one application program is configured to perform the function, and the determining the at least one application program to recommend comprises determining that the at least one application program will offer a similar or better user experience compared to the user experience corresponding to the previous best user-experience rating; and
recommending the determined at least one application program to the user.

2. The computer-implemented method of claim 1, further comprising determining a type of application that the user is searching for, wherein the recommending comprises recommending at least one application program that is of the type of application that the user is searching for.

3. The computer-implemented method of claim 1, wherein the plurality of user-experience ratings comprises at least one of facial feedback, voice feedback, and textual feedback.

4. The computer-implemented method of claim 1, wherein the determining the at least one application program to recommend to the user comprises determining at least one application program that is not installed on a user device of the user.

5. The computer-implemented method of claim 1, wherein the determining that the at least one application program will offer a similar or better user experience comprises comparing the previous best user-experience rating to a global feedback for the function of the application program that corresponds to the previous best user-experience rating.

6. The computer-implemented method of claim 1, wherein the determining that the at least one application program will offer a similar or better user experience comprises comparing the previous best user-experience rating to a personalized rating of the at least one application program to the user, and the personalized rating is based on a global rating of the at least one application program.

7. The computer-implemented method of claim 1, further comprising capturing user-experience feedback relating to the user's use of the function across the plurality of application programs.

8. A computer system comprising:
a memory; and
a processor system communicatively coupled to the memory;
the processor system configured to perform a method comprising:
determining a plurality of user-experience ratings relating to a user's previous use of a plurality of functions of a plurality of application programs, wherein at least one user-experience rating of the plurality of user-experience ratings comprises a previous best user-experience rating for a function of the plurality of functions, and the previous best user-experience rating corresponds to the best previous experience that the user had when using the function;
determining at least one application program to recommend to the user, wherein the recommended at least one application program is configured to perform the function, and the determining the at least one application program to recommend comprises determining that the at least one application program will offer a similar or better user experience compared to the user experience corresponding to the previous best user-experience rating; and
recommending the determined at least one application program to the user.

9. The computer system of claim 8, wherein the method further comprises determining a type of application that the user is searching for, wherein the recommending comprises recommending at least one application program that is of the type of application that the user is searching for.

10. The computer system of claim 8, wherein the plurality of user-experience ratings comprises at least one of facial feedback, voice feedback, and textual feedback.

11. The computer system of claim 8, wherein the determining the at least one application program to recommend to the user comprises determining at least one application program that is not installed on a user device of the user.

12. The computer system of claim 8, wherein the determining that the at least one application program will offer a similar or better user experience comprises comparing the previous best user-experience rating to a global feedback for the function of the application program that corresponds to the previous best user-experience rating.

13. The computer system of claim 8, wherein the determining that the at least one application program will offer a similar or better user experience comprises comparing the previous best user-experience rating to a personalized rating of the at least one application program to the user, and the personalized rating is based on a global rating of the at least one application program.

14. The computer system of claim 8, wherein the processor system is further configured to capture user-experience feedback relating to the user's use of the function across the plurality of application programs.

15. A computer program product comprising a computer-readable storage medium having program instructions embodied therewith, the program instructions readable by a processor system to cause the processor system to:
determine a plurality of user-experience ratings relating to a user's previous use of a plurality of functions of a plurality of application programs, wherein at least one user-experience rating of the plurality of user-experience ratings comprises a previous best user-experience rating for a function of the plurality of functions, and the previous best user-experience rating corresponds to the best previous experience that the user had when using the function;
determine at least one application program to recommend to the user, wherein the recommended at least one application program is configured to perform the function, and the determining the at least one application program to recommend comprises determining that the at least one application program will offer a similar or better user experience compared to the user experience corresponding to the previous best user-experience rating; and
recommend the determined at least one application program to the user.

16. The computer program product of claim 15, wherein the processor system is further caused to determine a type of application that the user is searching for, wherein the recommending comprises recommending at least one application program that is of the type of application that the user is searching for.

17. The computer program product of claim 15, wherein the plurality of user-experience ratings comprises at least one of facial feedback, voice feedback, and textual feedback.

18. The computer program product of claim 15, wherein the determining the at least one application program to recommend to the user comprises determining at least one application program that is not installed on a user device of the user.

19. The computer program product of claim 15, wherein the determining that the at least one application program will offer a similar or better user experience comprises comparing the previous best user-experience rating to a global feedback for the function of the application program that corresponds to the previous best user-experience rating.

20. The computer program product of claim 15, wherein the determining that the at least one application program will offer a similar or better user experience comprises comparing the previous best user-experience rating to a personalized rating of the at least one application program to the user, and the personalized rating is based on a global rating of the at least one application program.
